(19) United States
(12) Patent Application Publication
(10) Pub. No.: US 2017/0247521 A1
(43) Pub. Date: Aug. 31, 2017

(54) HYDROPHILIC OPEN CELL FOAMS WITH PARTICULATE FILLERS

(71) Applicant: 3M INNOVATIVE PROPERTIES COMPANY, St. Paul, MN (US)

(72) Inventors: Thomas W. Blackburn, Ontario (CA); Tony R. Carrozzella, Ontario (CA); Ibrahim S. Gunes, Minneapolis, MN (US)

(21) Appl. No.: 15/511,277

(22) PCT Filed: Sep. 11, 2015
(86) PCT No.: PCT/US2015/049559

§ 371 Date: Mar. 15, 2017

Related U.S. Application Data
(60) Provisional application No. 62/051,513, filed on Sep. 17, 2014.

(51) Int. Cl. C08J 9/00; A47L 13/16; B32B 5/18; C08L 75/04; C08K 3/36

(52) U.S. Cl. CPC C08J 9/008; C08L 75/04; C08K 3/36; B32B 5/18; A47L 13/16; C08L 2203/14; C08J 2375/04; C08J 2403/02; C08J 2401/28; C08J 2497/02; C08K 2201/011; C08J 2205/05; C08J 2201/038; C08J 2207/12; B32B 2266/0278; B32B 2266/06; B32B 2307/726; B32B 2264/102; B32B 2432/00

(57) ABSTRACT

Embodiments herein are related to hydrophilic open cell foams with particulate fillers. In an embodiment, an article is provided that has an open cell foam structure including a hydrophilic polymer and about 0.1 wt. % to about 40.0 wt. % of a particulate filler dispersed within the hydrophilic polymer. The open cell foam structure can exhibit a rate of absorption of water greater than an otherwise identical foam lacking the particulate filler. Other embodiments are included herein.

### BACKGROUND

Hydrophilic foams have many industrial and consumer applications. By way of example, hydrophilic foams having an open cell structure can be used to absorb water. Some types of hydrophilic foams can exhibit reversible water absorption. For example, after water absorption into the open cell network, water can be released by applying pressure to the open cell structure. In this manner, such hydrophilic foams can be used to take up water and then release it and be used as sponges for various cleaning applications.

Hydrophilic foams can be formed of various materials, including both natural and synthetic materials. In particular, polymeric materials can be used to form hydrophilic foams. By way of example, cellulose is a common material used in forming hydrophilic foams.

### SUMMARY

Embodiments herein are related to hydrophilic open cell foams with particulate fillers. In an embodiment, an article is included that has an open cell foam structure including

a hydrophilic polymer and about 0.1 wt. % to about 40.0 wt. % of a particulate filler dispersed within the hydrophilic polymer. The open cell foam structure can exhibit a rate of absorption greater than an otherwise identical foam lacking the particulate filler.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

Embodiments may be more completely understood in connection with the following drawings, in which:

FIG. 1 is schematic cross-sectional view of an article in accordance with various embodiments herein;

FIG. 2 is a schematic cross-sectional view of an article in accordance with various embodiments herein; and

FIG. 3 is a schematic cross-sectional view of an article in accordance with various embodiments herein.

While embodiments herein are susceptible to various modifications and alternative forms, specifics thereof have been shown by way of example and drawings, and will be described in detail. It should be understood, however, that the embodiments are not limited to the particular embodiments described. On the contrary, the intention is to cover modifications, equivalents, and alternatives falling within the spirit and scope of that described herein.

### DETAILED DESCRIPTION

As described above, hydrophilic foams with open cell structures have many applications. One exemplary area of application is cleaning applications. Many existing foam products rely upon cellulose-based hydrophilic foams. Other types of hydrophilic foams can be more economical than cellulose-based hydrophilic foams. However, many previous non-cellulosic hydrophilic foams have not had sufficient functional properties to represent a viable substitute for cellulose-based hydrophilic foams. Embodiments here are directed to hydrophilic foams with open cell structures that exhibit desirable functional properties. It has been discovered that certain particulate fillers have a remarkable effect on the functional properties of the resulting hydrophilic open-cell foam. Such functional properties can include, but are not limited to, increased “hand” (i.e., feel), as compared to traditional cellulosic open cell structures, greater rate of absorption than an otherwise identical foam lacking the particulate filler, and a greater wet wipe water holding capacity than an otherwise identical open cell foam structure lacking the particulate filler material. In an embodiment, an article is included that has an open cell foam structure including a hydrophilic polymer and about 0.1 wt. % to about 40.0 wt. % of a particulate filler dispersed within the hydrophilic polymer.

Various embodiments will now be described in detail, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Hydrophilic Polymers

Hydrophilic foams herein can include polyurethane foams, polyurea foams, polyurethane/polyurea foams, polyester polyurethane foams, polyvinylalcohol foams, polyethylene foams, and the like.

Hydrophilic foams can be made in various ways. In the context of polyurethanes, one approach is a one-step (or “one shot”) process, in which all components are mixed simultaneously and the mixture is converted into the foam product through the reaction of isocyanate with a polyol (or polyhydroxy compound) to create the polymer and isocyanate with water to produce CO₂ gas to blow the foam. Alternatively, a two-step (or “prepolymer process”) can be used in which a polyol component can be reacted with an excess of isocyanate to obtain an isocynate terminated prepolymer. Then in a second step the prepolymer is reacted with a short polyol, water or polyamine called a chain extender or curing agent to obtain the foam product. Amine catalysts are frequently used to catalyze the isocyanate-water reaction (“blowing catalyst”) and tin or other metal catalysts can be used to regulate the rate of the isocyanate-polyol reaction (“gelling catalyst”). Polyureas can be similarly formed through the reaction of a di- or poly-isocyanate with a polyamine. Polyurethane/polyurea hybrids can be formed through the reaction of a di- or poly-isocyanate with a blend of amine-terminated polymer resin and a hydroxyl containing polyol.

Exemplary polyols can include polyester polyols, polyether polyols, polyester-polyether polyols, polyalkylene polyols. In various embodiments, polyols having molecular weight between about 60 and about 10,000 are used. In various embodiments, polyols having molecular weight between about 1,000 and about 9,000 are used. In various embodiments, polyols having molecular weight between about 1,000 and about 6,500 are used.

It will be appreciated that polyols and/or di- or poly-isocyanates herein can also include various functional groups. By way of example, polyols herein can specifically include sulfonated polyols. In various embodiments, the hydrophilic polymer can be a sulfonated polyurethane polymer. In various embodiments, the hydrophilic polymer can be a sulfonated polyurea/polyurethane polymer. Exemplary sulfonated polyols and resulting sulfonated polyurea and polyurethane polymers are described in U.S. Pat. No. 4,638,017, the content of which is herein incorporated by reference.

### Isocyanates

Isocyanates can include di- or poly-isocyanates. Isocyanates can be aromatic or aliphatic. Isocyanates can be a monomer, polymer or any variant reaction of isocyanates, quasi-pre-polymer or a pre-polymer. Exemplary isocyanates can specifically include hexamethylene diisocyanate, toluene diisocyanate (TDI), isophorone diisocyanate, 3,5,5-trimethyl-1-isocyanato-3-isocyanatomethylcyclohexane, 4,4′-diphenylmethane diisocyanate (MDI), 4,4,4″-triisocyanatotriphenylmethane, and the polymethylenepolyphenylisocyanates. Other polyisocyanates can include those described in U.S. Pat. Nos. 3,700,643 and 3,600,359, among others. Mixtures of polyisocyanates can also be used. Exemplary isocyanates are commercially available under the trade names VORALUX, from Dow Chemical Company; CORONATE, from Nippon Polyurethane; LUPRANAT, from BASF Corp.; amongst others.

### Catalysts

Various catalysts can be used. In some embodiments, the catalyst can include amine catalysts, including but not limited to, tertiary amine catalysts. Catalysts can include triethylenediamine; bis(2-dimethylaminoethyl) ether; N, N-dimethylethanolamine; 1, 3, 5-tris (3-[dimethylamino]propyl)-hexahydro-s-triazine; N, N, N′, N″, N″-pentamethyldiethylenetriamine; N,N-dimethylcyclohexylamine; N,N-dimethylaminoethoxyethanol; 2, 2′-dimorpholinodiethylether; and N, N′-dimethylpiperazine; amongst others. In a particular embodiment, the catalyst can be a N-ethylmorpholine (NEM) tertiary amine catalyst with a purity greater than 97% based on GC analysis (commercially available under the vendor catalog number 04500 from Sigma-Aldrich Co., LLC, St. Louis, Mo., USA). Exemplary amine catalysts can also include those commercially available under the tradename TEGOAMIN, from EVONIK Industries.

### Particulate Fillers

In various embodiments, open cell foam structures herein can include a particulate filler. The particulate filler can be dispersed within the other components forming the open cell foam structure, such as the hydrophilic polymer.

The open cell foam structure can include various amounts of the particulate filler. In various embodiments, the open cell foam structure can include at least about 0.01 wt. % of a particulate filler, or at least about 0.05 wt. % of a particulate filler, or at least about 0.1 wt. % of a particulate filler, or at least about 0.2 wt. % of a particulate filler, or at least about 0.5 wt. % of a particulate filler, or at least about 1.0 wt. % of a particulate filler, or at least about 2.0 wt. % of a particulate filler, or at least about 5.0 wt. % of a particulate filler, or at least about 10 wt. % of a particulate filler, or at least about 15 wt. % of a particulate filler.

In various embodiments, the open cell foam structure can include less than about 40 wt. % of a particulate filler, less than about 30 wt. % of a particulate filler, or less than about 25 wt. % of a particulate filler, or less than about 20 wt. % of a particulate filler, or less than about 15 wt. % of a particulate filler, or less than about 10 wt. % of a particulate filler, or less than about 5 wt. % of a particulate filler, or less than about 2 wt. % of a particulate filler. In various embodiments, the amount of the particulate filler can be in a range wherein the lower bound and the upper bound of the range can be any of the preceding numbers provided that the upper bound is larger than the lower bound. By way of example, in some embodiments, the open cell foam structure can include from about 0.1 wt. % to about 40.0 wt. % of a particulate filler, or from about 0.1 wt. % to about 20.0 wt. % of a particulate filler.

The particular filler can exhibit various functional properties. In some embodiments,

the particulate filler exhibits an absorption capacity of less than about 100 times its weight, or less than about 75 times its weight, or less than about 50 times its weight, or less than about 25 times its weight, or less than about 10 times its weight, or less than about 5 times its weight. In various embodiments, the particulate filler is a non-superabsorbent material.

In some embodiments, the particulate filler can have a hydrophilic outer surface. In some embodiments, the particulate filler can have a hydrophobic outer surface. In various embodiments, the particulate filler can have an outer surface having substantial amounts of unreacted hydroxyl groups. It will be appreciated that such hydroxyl groups can be capable of forming bonds through various reactions. However, in various embodiments the particulate filler is not covalently linked to the hydrophilic polymer or other components forming the hydrophilic foam.

The particulate filler can be formed from various materials. In some embodiments, the particulate filler can be formed from materials including hydroxyl groups on the surface thereof. In some embodiments, the particulate filler can be formed from materials including, but not limited to, nanosilica particles, nanostarch particles, other polysaccharide particles, cellulose particles, carboxymethyl cellulose particles, and wood particles (or wood flour). Examples of cellulose powder include Sigmacell cellulose powder. An example of a carboxymethyl cellulose particle includes AQUALON CMC 7MF from Hercules Inc., Wilmington, Del., USA. One example of a commercially available nanostarch particle is Ecosphere 2202™ from EcoSynthetix Ltd., or Ecosynthetix Inc. of Burlington, Ontario, Canada. Ecosphere 2202™ is a starch based, internally crosslinked, colloid forming hydrogel particle having an average particle size under 400 nm. In particular, the Ecosphere 2202™ particles have a number average particle size in the range of 50 to 150 nm and, considering a distribution of their particle sizes, are also predominantly in the range of 50 to 150 nm in size. These products are made primarily from starch including amylose and amylopectin. The product is provided in the form of a dry powder of agglomerated nanoparticles with a volume mean diameter of about 300 microns. When mixed in water and stirred, the agglomerates break apart and form a stable dispersion of the nanoparticles. Aspects of such particles are described in U.S. Pat. No. 6,677,386 and U.S. Publ. No. 2012/0309246, the contents of which are herein incorporated by reference.

In some embodiments, the particulate filler can have a particle size on the nanometer scale. In various embodiments, the particulate filler can have an average particle size of greater than about 1 nm, 2 nm, 5 nm, 10 nm, 20 nm, 50 nm, 100 nm, 200 nm, 300 nm, or 400 nm. In some embodiments, the particulate filler can have an average particle size of less than about 1000 nm, 800 nm, 600 nm, 500 nm, 400 nm, 300 nm, or 200 nm. In some embodiments, the average size of the particulate filler can be in a range wherein the lower bound and the upper bound of the range can be any of the preceding numbers provided that the upper bound is larger than the lower bound. By way of example, in some embodiments, the particulate filler can have an average particle size of about 10 nm to about 500 nm.

In some embodiments, the particulate filler can have a particle size on the millimeter scale. In various embodiments, the particulate filler can have an average particle size of greater than about 0.1 mm, 0.25 mm, 0.5 mm, 0.75 mm, or 1 mm. In some embodiments, the particulate filler can have an average particle size of less than about 5 mm, 2.5 mm, 1.5 mm, or 1.0 mm. In some embodiments, the average size of the particulate filler can be in a range wherein the lower bound and the upper bound of the range can be any of the preceding numbers provided that the upper bound is larger than the lower bound. By way of example, in some embodiments, the particulate filler can have an average particle size of about 0.5 mm to about 1.5 mm.

### Additional Components

It will be appreciated that hydrophilic foams herein can include various other components in addition to those described above. By way of example, surfactants can be used in various embodiments herein. While not intending to be bound by theory, surfactants can be useful to help regulate cell size in the resulting open cell structure. The surfactants can be nonionic, anionic, cationic, zwitterionic or amphoteric, alone or in combination. Surfactants can include, but are not limited to, sodium dodecyl sulfate, sodium stearyl sulfate, sodium lauryl sulfate, pluronics, or the like. Examples of surfactants that can be used in hydrophilic foams are described in US Publ. Pat. App. No. 2008/0305983, the content of which relating to surfactants is herein incorporated by reference. Exemplary surfactants are commercially available under the trade names TEGOSTAB, ORTEGOL, from Evonik Goldschmidt Corp., DYNOL, from Air Products & Chemicals, Inc.; PLURONIC, from BASF Corp; TETRONIC, from BASF Corp.; and TRITON X-100, from Dow Chemical Company.

In some embodiments, blowing agents can be included. Blowing agents can include, but are not limited to: C1 to C8 hydrocarbons, C1 and C2 chlorinated hydrocarbons such as methylene chloride, dichloroethene, monofluorotrichloro-methane, difluorodichloromethane, acetone, as well as nonreactive gases such as carbon dioxide, nitrogen, or air.

In various embodiments, dyes or other coloring agents can be used in hydrophilic foams herein. In various embodiments, fire or flame-retardant materials can be included in hydrophilic foams herein. In various embodiments, antimicrobial, antibacterial or antiseptic materials can be included in hydrophilic foams herein. Other components can include fibers, deodorants, medicinals, alcohols, and the like.

### Articles and Methods

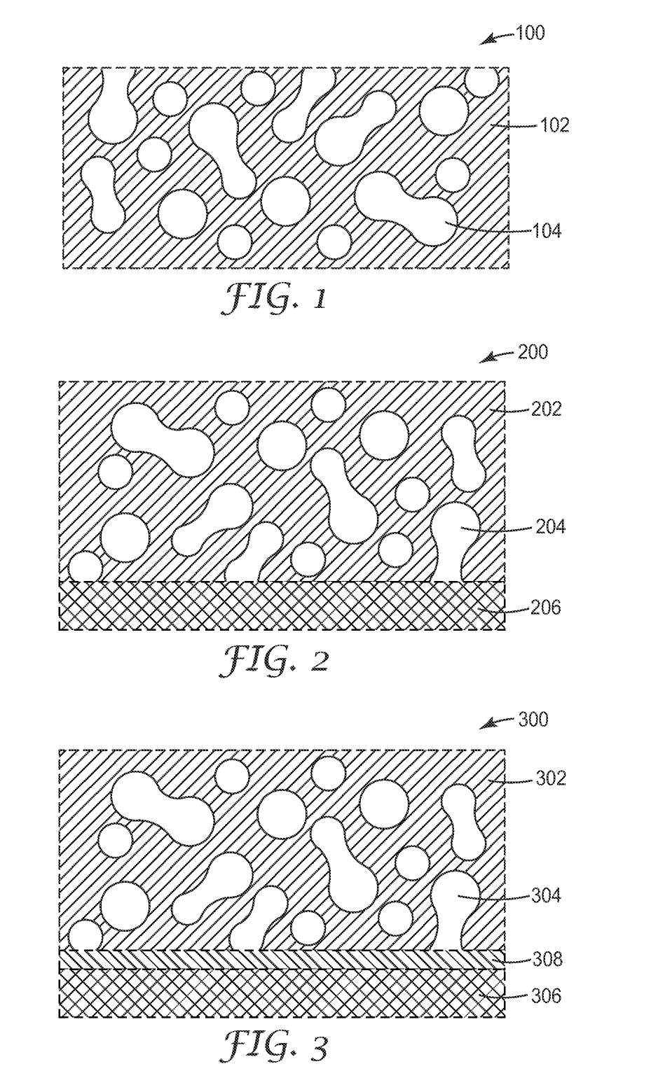

In various embodiments herein, an article is included. The article can include an open cell foam structure. In various embodiments, the open cell foam structure can be in the form of a planar layer. However, it will be appreciated that the open cell foam structure can also take on various other shapes. Referring now to FIG. 1, a schematic cross-sectional view of an article 100 in accordance with various embodiments is shown. The article 100 can include an open cell foam structure 102. The open cell foam structure 102 includes a plurality of interconnected pores 104 into which a fluid, such as water, can be absorbed and then released. In this embodiment, the open cell foam structure 102 is configured as a planar layer.

In some embodiments, an article can include one or more additional layers on one or more sides of the article. Such layers can include various materials, including, but not limited to, woven materials, nonwoven materials, knitted materials, fabrics, foams, sponges, films, printed materials, vapor-deposited materials, plastic netting, and the like.

In some embodiments, an article herein can include a scouring layer. Referring now to FIG. 2, a schematic cross-sectional view of an article 200 in accordance with various embodiments herein is shown. The article 200 can include an open cell foam structure 202. The open cell foam structure 202 can include a plurality of interconnected pores 204 into which a fluid, such as water, can be absorbed and then released. The article 200 can further include a scouring layer 206. In some embodiments, the open cell foam structure 202 can be disposed over the scouring layer 206.

The scouring layer can be formed from various materials. The scouring layer can be made from various materials including, but not limited to: woven, nonwoven, knitted, fabrics, foams, sponges, films, printed materials, vapor-deposited materials, plastic netting, and the like. In some embodiments, the scouring layer can be a coated abrasive layer, a fabric that is pattern-coated or printed with an abrasive resin, or a structured abrasive film. Exemplary materials for scouring layers are described in U.S. Pat. Nos. 4,055,029; 7,829,478; and U.S. Publ. App. No. 2007/0212965.

In some embodiments, the scouring layer can include a lofty, fibrous, nonwoven abrasive product. Exemplary scouring layer materials are described in U.S. Pat. Nos. 4,991,362 and 8,671,503, the contents of which are herein incorporated by reference. The scouring layer can include a porous structure defining pores.

In various embodiments, the scouring layer is directly bonded to the open cell foam structure. By way of example, the composition for forming the hydrophilic foam can be poured onto the scouring layer before the materials of the hydrophilic foam sets up (for example, prior to gel time) such that the hydrophilic foam will be intermixed into the pores of the scouring layer causing the open cell foam structure to be directly bonded to the scouring layer. The open cell foam structure can be at least partially disposed within the pores of the porous structure.

In other embodiments, the scouring layer can be indirectly bonded to the open cell foam structure. By way of example, an adhesive can be used to bond the scouring layer to the open cell foam structure. The adhesive may cover some or the entire surface of the interface between the scouring layer and the open cell foam structure. In some embodiments, the article can include a layer of an adhesive disposed between the scouring layer and the planar layer of the open cell foam structure. Referring now to FIG. 3, a schematic cross-sectional view of an article 300 in accordance with various embodiments herein is shown. The article 300 can include an open cell foam structure 302. The open cell foam structure 302 can include a plurality of interconnected pores 304 into which a fluid, such as water, can be absorbed and then released. The article 300 can further include a scouring layer 306. A layer of an adhesive 308 can further be disposed in between the scouring layer 306 and the layer of the open cell foam structure 302.

### Functional Properties

As used herein, comparisons to an “otherwise identical” structure or composition lacking a particular component refer to a structure or composition that includes everything except for the particular component in percentage amounts (such as weight percent amounts) that are greater to account for the absence of the particular component. By way of example, if a given composition was formed of 33.3 wt. % component A, 33.3 wt. % component B, and 33.3 wt. % component C, then a composition that is otherwise identical to this composition, but lacking component C, would be formed of 50 wt. % component A and 50 wt. % component B.

In some embodiments, the open cell foam structure and/or articles including the open cell foam structure can exhibit a fast rate of absorption of water. By way of example, in some embodiments, the open cell foam structure and/or articles including the same can exhibit a rate of absorption greater than 30 grams of water in 5 seconds, or a rate of absorption greater than 40 grams of water in 5 seconds, or a rate of absorption greater than 50 grams of water in 5 seconds, or a rate of absorption greater than 60 grams of water in 5 seconds, or a rate of absorption greater than 70 grams of water in 5 seconds. In various embodiments, the open cell foam structure can exhibit a rate of absorption of water that is greater than an otherwise identical open cell foam structure lacking the particulate filler material.

In some embodiments, the open cell foam structure and/or articles including the open cell foam structure can exhibit a desirable wet wipe water holding capacity. By way of example, in some embodiments, the open cell foam structure can exhibit a wet wipe water holding capacity of greater than about 1.0 g/g foam, or greater than about 1.5 g/g foam, or greater than about 2.0 g/g foam, or greater than about 2.5 g/g foam, or greater than about 3.0 g/g foam, or greater than about 3.5 g/g foam. In various embodiments, the open cell foam structure can exhibit a wet wipe water holding capacity that is greater than an otherwise identical open cell foam structure lacking the particulate filler material.

Embodiments of open cell foam structure can have various densities. In some embodiments, the open cell foam structure can have a density of greater than 2.50 PCF (pounds per cubic foot). In some embodiments, the open cell foam structure can have a density between about 2.50 PCF and about 6.00 PCF.

The ratio between the absorption capacity for a particular liquid under a given pressure and the absorption capacity for that liquid without pressure (or free absorption capacity) can be referred to as the retention (or retention capacity). In various embodiments herein, the retention for water expressed as a percentage for a pressure of 35 mmHg is less than about 95%, or less than about 90%, or less than about 75%, or less than about 60%, or less than about 50%, or less than about 40%, or less than about 30%, or less than about 20%, or less than about 10%.

### EXAMPLES

### Materials:

The following materials were used in these examples.

TABLE 1

| Material | Description |
|---|---|
| Polyol | Sulfonated polyol made as per “Preparatory Example 1” of |
| | U.S. Pat. No. 4,638,017. |
| Prepolymer-1 | Sulfonated prepolymer made as per “Preparatory Example |
| | 2” of U.S. Pat. No. 4,638,017. |
| Prepolymer-2 | Hydrophilic polyurethane prepolymer based on MDI |
| | commercially available under the trade designation of |
| | HYPOL JM 5005 from DOW CHEMICAL COMPANY, |
| | Midland, MI, USA. |
| Isocyanate | Carbodiimide-modified diphenyl diisocyanate (MDI) |
| | commercially available under the trade designation of |
| | ISONATE 134L from DOW CHEMICAL COMPANY, |
| | Midland, MI, USA. |
| Surfactant-1 | A non-ionic, difunctional block copolymer surfactant |
| | terminating in primary hydroxyl groups, with an average |
| | molecular weight of 2200 and with a specific gravity of 1.05 |
| | determined at 25 C, commercially available under the trade |
| | designation of PLURONIC L44 NF INH from BASF |
| | CORPORATION, Florham Park, New Jersey, USA. |
| Surfactant-2 | A silicone fluid, commercially available under the trade |
| | designation of TEGOSTAB B 8408 from EVONIK |
| | GOLDSCHMIDT CORPORATION, Hopewell, VA, USA. |
| Surfactant-3 | A silicone fluid, commercially available under the trade |
| | designation of TEGOSTAB B 8404 from EVONIK |
| | GOLDSCHMIDT CORPORATION, Hopewell, VA, USA. |
| Surfactant-4 | A non-ionic, tetrafunctional block copolymer surfactant |
| | terminating in primary hydroxyl groups, with an average |
| | molecular weight of 15,000 and with a specific gravity of |
| | 1.04 determined at 25 C, commercially available under the |
| | trade designation of TETRONIC 1107 from BASF |
| | CORPORATION, Florham Park, New Jersey, USA. |
| Catalyst | N-ethylmorpholine (NEM) tertiary amine catalyst with a |
| | purity greater than 97% (based on GC analysis) |
| | commercially available under the vendor catalog number |
| | 04500 from SIGMA-ALDRICH CO., LLC, St. Louis, MO, |
| | USA. |
| Biopolymer | Cross-linked biopolymer nanoparticles with chemically |
| | modified starch content of 90-99% by weight and with |
| | particle size upon dispersion of 50-150 nm commercially |
| | available under the trade designation ECOSPHERE 2202 |
| | BIOLATEX BINDER from ECOSYNTHETIX |
| | CORPORATION, Burlington, ON, CA. |
| Wood Flour | Fine wood flour with an average particle size of |
| | approximately 0.6 mm (30 mesh), commerically available |
| | from ONTARIO SAWDUST SUPPLIES LTD., Holland |
| | Landing, ON, CA. |
| Silica | Colloidal silica with an average particle size of 60 nm and |
| | with a specific gravity of 1.39, commercially available under |
| | trade designation of NALCO 1060 from NALCO |
| | COMPANY, Naperville, IL, USA. |
| Calcium carbonate | Fine, dry ground calcium carbonate powder with a specific |
| | gravity of 2.70 g/cc and with a median particle diameter of |
| | 3.5 μm, commercially available under the trade designation |
| | of OMYACARB 4-LU from OMYA INTERNATIONAL |
| | AG, Switzerland. |
| CMC | Water soluble sodium carboxymethyl cellulose with a dry |
| | minimum purity of 99.5%, commercially available under the |
| | trade designation of AQUALON CMC 7MF from |
| | HERCULES INCORPORATED, Wilmington, DE, USA. |
| Yellow colorant | Anionic yellow pigment dispersion with a density of 1.03 g/cm3 |
| | (determined at 20° C.) commercially available under |
| | the trade designation SOLAR YELLOW 42L from BASF |
| | CORPORATION, Florham Park, New Jersey, USA. |

Standard Procedure to Prepare Foam Samples with the Prepolymer:

1. The catalyst and deionized water were placed in a glass beaker and hand mixed for 5 minutes to obtain a mixture which contained 20 wt. % catalyst. This mixture was called the catalyst solution.

2. A first mixture of tap water and other additives, such as surfactant, catalyst solution,

pigment, and filler was prepared. The ingredients were weighed out to the nearest 0.01 grams and put in a glass beaker. The mixture in the beaker was then mixed by hand for 3-5 minutes until the solution is homogenous.

3. In a separate, polyethylene rigid container, the desired prepolymer(s) was weighed out to the nearest 0.01 grams.

4. A laboratory bench-top mixer equipped with a 4-propeller blade and which had a blade diameter of 10.2 cm was used in the experiments. The maximum mixer speed was set to 3000 rpm.

5. To prepare the second mixture made of the first mixture and the prepolymer(s), the mixer was started and the rotating blade was immersed into the polyethylene rigid container which already contained the prepolymer(s). Care was exercised to prevent the blades from touching the sides and bottom of the container. Once the rotation speed of the mixer reached 3000 rpm, the first mixture was quickly added to the rigid polyethylene container to start mixing the prepolymer(s) with the first mixture.

6. The first mixture and the prepolymer(s) were mixed for 30 seconds to obtain the second mixture. The blade was moved around the container in a circular motion during mixing. Care was exercised to prevent the blades from touching the sides and bottom of the container.

7. After 30 seconds, the mixer was stopped, the blade was removed out of the container, and the second mixture in the container was left undisturbed on a laboratory bench. The foaming of the second mixture was visually monitored.

8. The foam prepared from the second mixture was left undisturbed for a minimum of 5 minutes at 25 C before it was cut to obtain specimens used in further tests. Rectangular prism-shaped foam samples with approximate dimensions of 12 cm in length, 7.6 cm in width, and 1.5 cm in thickness were cut for further testing.

Standard Procedure to Prepare Foam Samples with the Polyol:

1. The catalyst and deionized water were placed in a glass beaker and hand mixed for 5 minutes to obtain a mixture that contained 20 wt. % catalyst. This mixture was called the catalyst solution.

2. A laboratory bench-top mixer equipped with a 4-propeller blade and which had a blade diameter of 10.2 cm was used in the experiments. The maximum mixer speed was set to 3000 rpm.

3. The desired ingredients, such as polyol, tap water and other additives, such as surfactant, catalyst solution, pigment, and filler were weighed out to the nearest 0.01 grams and put in a rigid polyethylene beaker.

4. The first mixture was obtained by mixing the desired ingredients with the help of the bench-top laboratory mixer at 3000 rpm until it was homogenous. The blade was moved around the container in a circular motion during mixing. Care was exercised to prevent the blades from touching the sides and bottom of the container.

5. The isocyanate was separately weighed out in a rigid polyethylene container to the nearest 0.01 grams. Upon the first mixture became visually homogenous, the isocyanate was quickly added to the first mixture.

6. The first mixture and the isocyanate were mixed for a further 10 seconds at 3000 rpm to obtain the second mixture. The blade was moved around the container in a circular motion during mixing. Care was exercised to prevent the blades from touching the sides and bottom of the container.

7. After 10 seconds, the mixer was stopped, the blade was removed out of the container, and the second mixture in the container was left undisturbed on a laboratory bench. The foaming of the second mixture was visually monitored.

8. The foam prepared from the second mixture was left undisturbed for a minimum of 5 minutes at 25 C before it was cut to obtain specimens used in further tests. Rectangular prism-shaped foam samples with approximate dimensions of 12 cm in length, 7.6 cm in width, and 1.5 cm in thickness were cut for further testing.

### Test Procedures

The as-prepared foam samples which were kept at ambient laboratory temperature and humidity were designated as dry foam samples. Any measurement taken from the dry foam sample was designated as a dry measurement. The ambient temperature in the laboratory was measured to be approximately 25° C. and the ambient humidity was measured to be approximately 50% RH.

### Dry Density:

Foams herein can have various dry densities. In some applications, densities that are of the same order of magnitude as for commercial cellulose foams are desirable. The density of the foams was assessed according to the following procedure.

1. The length, width, and thickness of the as-prepared foam samples were measured to the nearest 0.01 mm with the help of a caliper. If the sample was not uniform in shape, multiple measurements for the length, width and thickness were recorded. The arithmetic mean of multiple measurements for each parameter, length, width, and thickness was used as the representative value in calculation of the sample volume. The volume was calculated by multiplying the length, width, and thickness values of the foam.

2. The weight of the as-prepared foam sample was determined to the nearest 0.01 grams.

3. The dry density was calculated by dividing the measured weight to the calculated volume.

### Dry Wet-Out Time:

The duration of time for a droplet of tap water to be completely absorbed by a dry foam sample was designated as ‘dry wet-out time’. For some applications, a relatively short dry wet-out time can be desirable because a shorter duration can be an indicator of faster water absorption. Dry wet-out time was assessed according to the following procedure.

1. A droplet of tap water was slowly placed on the surface of the dry foam with the help of a pipette.

2. The water droplet was visually observed. The duration of time for the droplet to completely wet out the foam surface was determined with a stopwatch and considered as ‘dry wet-out time’.

3. Water droplets placed on some samples were almost instantaneously absorbed by the sample and no reasonable time measurement was possible. In that case, the dry-wet out time for that sample was recorded as ‘instantaneous’.

### Percent Swell:

The extent of swelling when a dry foam sample was completely submerged in tap water and after it was allowed to soak tap water for one minute was designated as percent swell. It will be appreciated that foams herein can exhibit various amounts of swelling. However, for some applications a relatively lower percent swell can be desirable.

1. The length, width, and thickness of the as-prepared foam samples were measured to the nearest 0.25 mm with the help of a caliper. If the sample was not uniform in shape, multiple measurements for the length, width and thickness were recorded. The arithmetic mean of multiple measurements for each parameter, length, width, and thickness was used as the representative value in calculation of the sample volume. The dry volume was calculated by multiplying the length, width, and thickness values of the dry foam.

2. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/immersion again cycle was repeated five times.

3. After completing five cycles, the foam sample was taken out of water and squeezed by hand pressure to remove as much soaked water as possible. Then, the water in the container was discarded and the container was filled with fresh tap water.

4. The foam sample was completely immersed in tap water in the container and was allowed to soak water for one minute.

5. Then, the foam sample was removed from the container and placed on the lab bench while exercising care not to compress the foam sample.

6. The length, width, and thickness of the foam samples were measured to the nearest 0.25 mm with the help of a caliper. These values were designated as wet dimensions. If the sample was not uniform in shape, multiple measurements for the length, width and thickness were recorded. The arithmetic mean of multiple measurements for each parameter, length, width, and thickness, was used as the representative value in calculation of the sample volume. The wet volume was calculated by multiplying the wet length, width, and thickness values of the foam.

7. The percent swell is calculated by dividing the difference between the wet volume and the dry volume to dry volume and multiplying it by 100.

### Wet Wipe Water Holding Capacity:

Wet wipe water holding capacity can be indicative of how a foam takes up and reversibly holds onto water. A relatively high wet wipe water holding capacity can be useful in various applications including, but not limited to, cleaning applications. The following procedure was used to determine wet wipe water holding capacity.

1. 25 grams of tap water was slowly poured onto a polished stainless steel plate.

2. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

3. After completing five cycles, the foam sample was taken out of water and squeezed by hand pressure to remove as much soaked water as possible. Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

4. The wrung foam sample was slowly passed across water poured on a polished stainless steel plate while the front end of the foam was slightly lifted to facilitate wiping action.

5. After the foam sample was passed across water, the weight of the foam sample which absorbed water was determined. This weight value was designated as the “first pass” weight.

6. The wet wipe water holding capacity was calculated by dividing the difference between the ‘first pass’ and ‘wrung weight’ by ‘wrung weight’.

### Percent Effective Absorption:

Percent effective absorption was the percent of water, by volume, that initially damp foam retained after it reached saturation level of water absorption and after it was left draining for five minutes. Relatively high percent effective absorption can be a useful property in various applications including, but not limited to, cleaning applications. The following procedure was used to determine the total amount of water a foam sample could hold, based on its volume and its damp weight.

1. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

2. After completing five cycles, the foam sample was taken out of water and squeezed by hand pressure to remove as much soaked water as possible Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

3. The wrung foam sample was completely immersed in tap water, while it was being squeezed to remove any entrapped air.

4. The foam sample was relaxed while it was still completely immersed in water, so that it could absorb water. The relaxed foam was left completely immersed in water for approximately one minute.

5. After one minute, the foam sample was removed from water. A binder clip was gently attached to an edge of the sample and the sample was left hanging on a draining rod for five minutes. Care was exercised when handling the sponge not to accidentally squeeze out any water.

6. After 5 minutes, the weight of the sample was determined to the nearest 0.01 gram and recorded as “wet weight.”

7. The percent effective absorption was calculated by dividing the difference between the wet weight and wrung weight by wrung weight and multiplying it by 100.

### Rate of Absorption:

Relatively high rate of absorption can be useful in various applications including, but not limited to, cleaning applications. In this test, the foam sample was placed on its largest face in a container that had 3.2 mm deep tap water. The amount of water that was absorbed by the foam sample within 5 seconds was determined and then a rate of absorption was calculated. The following procedure was used.

1. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

2. After completing five cycles, the foam sample was taken out of water and squeezed by hand pressure to remove as much soaked water as possible. Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

3. A perforated metal plate was placed in a rigid plastic container. Continuous water flow into and out of the container was facilitated to keep the water depth above the perforated metal plate constant at approximately 3.2 mm.

4. The foam sample was placed on its largest face onto the perforated metal plate and kept at this position for five seconds.

5. After five seconds, the foam sample was removed and its weight was determined to the nearest 0.01 gram. This value was recorded as “wet weight.”

6. The rate of absorption was calculated by dividing the difference between the wet weight and wrung weight by wrung weight and multiplying by 100.

### COMPARATIVE EXAMPLE

An unfilled foam sample which did not contain any filler was prepared as described in the section ‘Standard procedure to prepare foam samples with the prepolymer’. The properties of the unfilled foam were tested according to the test procedures as described in the ‘test procedures’ section and the properties were presented in TABLE 2. A commercially available cellulose sponge (O-Cel-O® Handy Sponge 7274-T available from 3M Company, St. Paul, Minn., USA) was also tested under the described test conditions and the results were reported in TABLE 2.

### Example 1

Foam samples filled with different amounts of the biopolymer were prepared as described in the section ‘Standard procedure to prepare foam samples with the prepolymer’. The properties of the foam samples filled with biopolymer were tested according to the test procedures as described in the ‘test procedures’ section and the properties were presented in TABLE 2 under the sample designations 1 to 6. The results indicated that substantial improvements in ‘% Effective Absorption’ and ‘Rate of Absorption’ properties were achieved in the presence of the biopolymer.

### Example 2

Foam samples filled with different amounts of the silica were prepared as described in the section ‘Standard procedure to prepare foam samples with the prepolymer’. The properties of the foam samples filled with silica were tested according to the test procedures as described in the ‘test procedures’ section and the properties were presented in TABLE 2 under the sample designations 7 to 8. The results indicated that substantial improvements in % Effective Absorption and Rate of Absorption properties were achieved in the presence of the silica.

### Example 3

Foam samples filled with different amounts of the wood flour were prepared as described in the section ‘Standard Procedure to Prepare Foam Samples with the Prepolymer’. The properties of the foam samples filled with wood flour were tested according to the test procedures as described in the ‘test procedures’ section and the properties were presented in TABLE 2 under the sample designations 9 to 10. The results indicated that substantial improvements in % Effective Absorption and Rate of Absorption properties were achieved in the presence of the wood flour.

### Example 4

CMC was mixed with tap water in a plastic beaker by hand mixing for 5 minutes to obtain an aqueous mixture which contained 3 wt % CMC. Foam samples filled with different amounts of the CMC/calcium carbonate combination and CMC/silica combination were prepared as described in the section ‘Standard procedure to prepare foam samples with the prepolymer’. The properties of the foam samples filled with these filler combinations were tested according to the test procedures as described in the ‘test procedures’ section. The properties of foam samples prepared from prepolymer-1 and prepolymer-2 and filled with CMC/calcium carbonate filler combination were presented in TABLE 3 under the sample designations 11-14. The properties of foam samples prepared from prepolymer-1 and prepolymer-2 and filled with CMC/silica filler combination were presented in TABLE 3 under the sample designations 15-18. The results indicated that substantially improved % Effective Absorption properties were achieved with foam samples prepared from prepolymer-1 and prepolymer-2 and filled with CMC/calcium carbonate and CMC/silica fillers.

The properties of the formulations, as tested, are shown below in Table 2 wherein the control was included to highlight the impact on functional properties of various particulate fillers in comparison to otherwise identical formulations lacking the particulate fillers. While addition of the fillers showed expected changes to physical properties, such as dry density, it was surprisingly observed that the addition of these fillers increased the % effective absorption, and/or the rate of absorption of the resultant foam in many cases.

TABLE 2

| | Commercial | | | | | | | | | | | |
|---|---|---|---|---|---|---|---|---|---|---|---|---|
| | cellulose | Sample No | | | | | | | | | | |
| | sponge | Unfilled | 1 | 2 | 3 | 4 | 5 | 6 | 7 | 8 | 9 | 10 |
| | weight of ingredient in the formulation (grams) | | | | | | | | | | | |
| Ingredients | | | | | | | | | | | | |
| Prepolymer-1 | NA | 100 | 100 | 100 | 100 | 100 | 100 | 100 | 100 | 100 | 100 | 100 |
| Water | NA | 50 | 50 | 50 | 50 | 50 | 18 | 0 | 40 | 30 | 50 | 50 |
| Catalyst Solution | NA | 0.5 | 0.5 | 0.5 | 0.5 | 0.5 | 0.5 | 0.5 | 0.5 | 0.5 | 0.5 | 0.5 |
| Surfactant-1 | NA | 1 | 1 | 0 | 0 | 0 | 1 | 1 | 1 | 1 | 1 | 1 |
| Biopolymer | NA | 0 | 10 | 15 | 15 | 15 | 20 | 31 | 0 | 0 | 0 | 0 |
| Silica | NA | 0 | 0 | 0 | 0 | 0 | 0 | 0 | 10 | 20 | 0 | 0 |
| Wood Flour | NA | 0 | 0 | 0 | 0 | 0 | 0 | 0 | 0 | 0 | 5 | 10 |
| Surfactant-2 | NA | 0 | 0 | 1 | 0 | 0 | 0 | 0 | 0 | 0 | 0 | 0 |
| Surfactant-3 | NA | 0 | 0 | 0 | 0 | 1 | 0 | 0 | 0 | 0 | 0 | 0 |
| Surfactant-4 | NA | 0 | 0 | 0 | 1 | 0 | 0 | 0 | 0 | 0 | 0 | 0 |
| Yellow Colorant | NA | 0 | 0.4 | 0.4 | 0.4 | 0.4 | 0.4 | 0.4 | 0.4 | 0.4 | 0.4 | 0.4 |
| Properties | | | | | | | | | | | | |
| Dry Wet-Out Time (seconds) | Inst. | Inst. | Inst. | 3 | Inst. | Inst. | Inst. | Inst. | Inst. | Inst. | Inst. | Inst. |
| Density (kg/m³) | 68.9 | 40 | 55 | 63 | 78 | 65 | 53.8 | 57.8 | 63.6 | 73.5 | 76.6 | 86.8 |
| % Swell | 43.4 | 24 | 15 | 33 | 38 | 38 | 29.9 | 30.1 | 43.4 | 28.6 | 23.4 | 26.2 |
| Wet-wipe Water Holding | 4.3 | 5.5 | 3.5 | 2.9 | 2.4 | 2.6 | 3.2 | 3.9 | 4.3 | 3 | 2.6 | 2.6 |
| Capacity (g/g foam) | | | | | | | | | | | | |
| % Effective Absorption | 95.5 | 47.8 | 77 | 90 | 68 | 68 | 58.5 | 50.8 | 95.5 | 37 | 49.3 | 61.5 |
| Rate of Absorption | 58.3 | 38 | 66 | 27 | 46 | 36 | 70.4 | 81.2 | 58.3 | 59.7 | 67.7 | 64.5 |

TABLE 3

| | Sample No | | | | | | | |
|---|---|---|---|---|---|---|---|---|
| | 11 | 12 | 13 | 14 | 15 | 16 | 17 | 18 |
| | weight of ingredient in the formulation (grams) | | | | | | | |
| Ingredients | | | | | | | | |
| Prepolymer-1 | 80 | 80 | 70 | 70 | 80 | 80 | 70 | 70 |
| Prepolymer-2 | 20 | 20 | 30 | 30 | 20 | 20 | 30 | 30 |
| Water | 20 | 10 | 0 | 0 | 30 | 30 | 10 | 10 |
| Catalyst | 1.2 | 1.2 | 1.2 | 1.2 | 1.2 | 1.2 | 1.2 | 1.2 |
| Solution | | | | | | | | |
| Surfactant-1 | 1 | 1 | 1 | 1 | 1 | 1 | 1 | 1 |
| CMC Solution | 20 | 20 | 40 | 40 | 20 | 20 | 40 | 40 |
| (3 wt %) | | | | | | | | |
| Silica | 20 | 40 | 20 | 40 | 0 | 0 | 0 | 0 |
| Calcium | 0 | 0 | 0 | 0 | 5 | 10 | 5 | 10 |
| carbonate | | | | | | | | |
| Yellow | 0.4 | 0.4 | 0.4 | 0.4 | 0.4 | 0.4 | 0.4 | 0.4 |
| Colorant | | | | | | | | |
| Properties | | | | | | | | |
| Dry Wet-Out | 2 | 6 | 4 | 16 | 2 | 2 | 13 | 20 |
| Time | | | | | | | | |
| (seconds) | | | | | | | | |
| Density | 55.1 | 60.1 | 57.2 | 54.1 | 84.1 | 85.2 | 81.4 | 80.3 |
| (kg/m³) | | | | | | | | |
| % Swell | 42.6 | 38.5 | 43.0 | 52.9 | 37.9 | 38.9 | 61.2 | 56.7 |
| Wet-wipe | 2.4 | 2.4 | 2.5 | 2.1 | 2.4 | 2.2 | 1.2 | 1.1 |
| Water | | | | | | | | |
| Holding | | | | | | | | |
| Capacity (g/g | | | | | | | | |
| foam) | | | | | | | | |
| % Effective | 81.1 | 77.9 | 85.5 | 113.1 | 68.9 | 70.4 | 105.4 | 112.6 |
| Absorption | | | | | | | | |
| Rate of | 31.9 | 23.2 | 29.7 | 12.1 | 21.5 | 16.0 | 8.9 | 4.7 |
| Absorption | | | | | | | | |

The various embodiments described above are provided by way of illustration only and should not be construed to limit the claims attached hereto. It will be recognized that various modifications and changes may be made without following the example embodiments and applications illustrated and described herein, and without departing from the true spirit and scope of the claims.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains. All publications and patent applications are herein incorporated by reference to the same extent as if each individual publication or patent application was specifically and individually indicated by reference.

1. An article comprising:
an open cell foam structure comprising
a hydrophilic polymer;
about 0.1 wt. % to about 40.0 wt. % of a particulate filler dispersed within the hydrophilic polymer;
the open cell foam structure exhibiting a rate of absorption of water greater than an otherwise identical foam lacking the particulate filler.

2. The article of claim 1, the open cell foam structure exhibiting a retention of water under a pressure of 35 mmHg of less than about 95%.

3. The article of claim 1, the particulate filler exhibiting an absorption capacity of water of less than about 100 times its weight.

4. (canceled)

5. The article of claim 1, the particulate filler comprising a non-superabsorbent material.

6. The article of claim 1, comprising a sponge.

7. The article of claim 1, the open cell foam structure exhibiting a rate of absorption of water greater than 40 grams in 5 seconds.

8. (canceled)

9. (canceled)

10. The article of claim 1, the open cell foam structure exhibiting a wet wipe water holding capacity of greater than about 2.5 g/g foam.

11. (canceled)

12. The article of claim 1, the open cell foam structure having a density between about 2.50 PCF and about 6.00 PCF.

13. The article of claim 1, the particulate filler having at least one of hydrophilic surfaces and hydrophobic surfaces.

14. (canceled)

15. The article of claim 1, the particulate filler comprising a surface having unreacted hydroxyl groups.

16. The article of claim 1, the particulate filler selected from the group consisting of nanosilica particles, nanostarch particles, carboxymethyl cellulose particles, and wood particles.

17. The article of claim 1, the particulate filler having an average particle size of about 10 nm to about 500 nm.

18. The article of claim 1, the particulate filler having an average particle size of about 0.5 mm to about 1.5 mm.

19. The article of claim 1, the hydrophilic polymer comprising sulfonate groups.

20. The article of claim 1, the hydrophilic polymer comprising at least one of a sulfonated polyurethane polymer, a polyurethane polymer and a polyurethane/polyuria polymer.

21. (canceled)

22. (canceled)

23. The article of claim 1, wherein the particulate filler is not covalently linked to the hydrophilic polymer.

24. The article of claim 1, the open cell foam structure comprising a planar layer.

25. The article of claim 24, further comprising a scouring layer, wherein the open cell foam structure is disposed over the scouring layer.

26. (canceled)

27. (canceled)

28. (canceled)

29. The article of claim 1, the open cell foam structure comprising about 0.1 wt. % to about 20.0 wt. % of the particulate filler dispersed within the hydrophilic polymer.

30. An article comprising:
an open cell foam structure comprising:
a hydrophilic polymer;
about 0.1 wt. % to about 40.0 wt. % of a particulate filler dispersed within the hydrophilic polymer.
